(19) United States
(12) Patent Application Publication
(10) Pub. No.: US 2019/0320043 A1
(43) Pub. Date: Oct. 17, 2019

(54) NETWORK COMPUTER SYSTEM TO GENERATE SYNTHETIC MESSAGES BASED ON SERVICE-SPECIFIC INFORMATION

(71) Applicant: Uber Technologies, Inc., San Francisco, CA (US)

(72) Inventors: Lawrence Benjamin Goldstein, San Francisco, CA (US); Jeremy Lermitte, San Mateo, CA (US); Arjun Vora, San Francisco, CA (US)

(21) Appl. No.: 15/953,285

(22) Filed: Apr. 13, 2018

(51) Int. Cl. H04L 29/08; H04L 12/58; G06N 99/00

(52) U.S. Cl. CPC H04L 67/327; G06N 99/005; H04L 51/02

(57) ABSTRACT

A network computer system operates to generate synthetic messages based on service-specific information. The network computer system communicates with user devices, including requester devices and provider devices, to match service requests generated by the requester devices to respective service provider entities associated with the provider devices. For a given service request generated by a respective requester device, the network computer system determines service-specific information using device data communicated by at least one of the respective requester device and a respective provider device. The respective provider device is associated with a service provider entity that is matched to the given service request. The network computer system detects a trigger based on the service-specific information. In response to detecting the trigger, the network computer system generates, based on the service-specific information, a synthetic message from a first device to a second device selected from the respective requester device and the respective provider device.

### BACKGROUND

Network computer systems can facilitate service arrangements between users, including on-demand service arrangements. Such service arrangements may require coordination between its users, which may include service providers and requesters. For example, an on-demand transport service often requires a requester and service provider to meet at a common location at the same time. Likewise, an on-demand delivery service may require a service provider to coordinate an order pickup with a business. In context of such on-demand services, effective coordination between requesters and providers can be difficult, as there are often distractions and limited time for requesters and providers to coordinate time, location or other aspects of the service. Even when a network computer system supports communication between users, the usefulness of any communication is limited by a user's speed, knowledge and accuracy. Furthermore, when a user composes a communication on a device, the user occupies resources that include time, display area, computing resources, and/or other resources.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates an example network computer system that generates synthetic messages based on service-specific information.

FIG. 2 illustrates an example of a service arrangement system that generates synthetic messages based on service-specific information.

FIG. 3 illustrates an example message template usable to generate synthetic messages based on service-specific information.

FIG. 4 illustrates an example service arrangement system that generates synthetic messages based on service-specific information using machine learning.

FIG. 5 illustrates a flow diagram of an example process for generating synthetic messages based on service-specific information.

FIG. 6 is a block diagram that illustrates a computer system on which examples described herein may be implemented

FIG. 7 is a block diagram that illustrates a computing device upon which examples described herein may be implemented.

Throughout the drawings, identical reference numbers designate similar, but not necessarily identical elements. The figures are not necessarily to scale, and the size of some parts may be exaggerated to more clearly illustrate the example shown. Moreover, the drawings provide examples and/or implementations consistent with the description. However, the description is not limited to the examples and/or implementations provided in the drawings.

### DETAILED DESCRIPTION

According to some examples, a messaging system is provided in connection with a service system, such as an on-demand transportation service system. The messaging system triggers automated composition of synthetic messages to facilitate communication and coordination between users, such as service providers and requesters of the service.

A synthetic message is a message that is computer-generated based on service-specific information. In many examples, a synthetic message is generated without input from a user. For example, a synthetic message can be generated on behalf of a requester that submits a service request, where the synthetic message is composed and/or transmitted, directly or indirectly (e.g., through a network service), to a device of a service provider that is matched to the service request. As another example, a synthetic message can be generated on behalf of a service provider that is to fulfill a service request, where the synthetic message is composed and/or transmitted, directly or indirectly to a device of a requester. With respect to such examples, synthetic messages can be automatically generated based on information specific to the service request, as well as to the fulfillment of the service request. According to examples, synthetic messages can facilitate communication and coordination between requesters and service providers, to facilitate efficient and successful completion of service requests.

In examples, content for synthetic messages are generated based on various kinds of service-specific information. Examples of service-specific information for a particular request include service request parameters (e.g., starting location, destination location, type of service), a service state of the service request (e.g., awaiting pickup, receiving transport, nearing completion, completed), requester-generated event information, provider-generated event information, other device data, user preferences, contextual information associated with the particular request, and/or other kinds of information.

In some implementations, a network computer system operates to generate synthetic messages based on service-specific information. The network computer system communicates with user devices to match service requests generated by requester devices to respective service provider entities associated with the provider devices. For a given service request generated by a respective requester device, the network computer system determines service-specific information using device data communicated by at least one of the respective requester device and a respective provider device. The respective provider device is associated with a service provider entity that is matched to the given service request. Additionally, the network computer system detects a trigger based on the service-specific information. A trigger is a set of one or more conditions for generating a synthetic message. In response to detecting the trigger, the network computer system generates, based on the service-specific information, a synthetic message.

In variations, a synthetic message can be generated to have a particular state. In some examples, a network computer system generates a synthetic message to have a composed state, such that a body of the message includes text, image and/or other content which a user (e.g., service provider or requester) can accept or modify before triggering the auto-composed message to be transmitted or otherwise delivered to a recipient (e.g., another user). Thus, in some examples, a synthetic message can be generated for a given user, and responsive to input from the given user, sent to a recipient (e.g., another user). In variations, a network computer system automatically generates and delivers a composed message, such that the message is auto-composed and automatically sent on behalf of one user, for another user. While many examples are described in which synthetic messages are composed on behalf of requesters and/or service providers, variations provide for use of synthetic messages in other context, such as between requesters or as between individual users that receive service from a service provider.

In some examples, a network computer system enables or otherwise facilitates communications which include synthetic messages. By way of example, the network computer system can generate a synthetic message, to be composed on behalf of a user of a first device, for transmission to a second device of another user.

In some implementations, the network computer system provides a communication confirmation feature for display at the first device. The communication confirmation feature is selectable at the first device to cause a communication comprising the synthetic message to be transmitted to the second device.

In some implementations, the network computer system generates multiple synthetic messages in response to a particular trigger and provides the option to send one of the synthetic messages. For example, in response to detecting the trigger, the network computer system may generate a second synthetic message based on the service-specific information from the first device to the second device. In some implementations, the network computer system provides a second communication confirmation feature for display at the first device. The second communication confirmation feature is selectable to cause a communication comprising the second synthetic message to be transmitted to the second device.

In some implementations, a network computer system detects a trigger for generating a synthetic message based on a determination that a requester device and/or provider device is approaching a location associated with a given service request. Still further, a network computer system detects a trigger for generating a synthetic message based on aggregation and analysis of communications sent between requester devices and/or provider devices in a given population of users (e.g., users of a given geographic region). The communications which are used for analysis can include human-generated messages, as well as programmatically generated messages which are utilized, approved or rejected by users.

Still further, in some examples, a network computer detects a trigger for generating a synthetic message based on a determination that a given service request or its fulfillment is associated with a level of complexity that satisfies a condition of complexity (e.g., higher level of complexity). A given service request may be associated with a higher level of complexity as a result of one or more conditions that exist with the given service request. In some examples, the higher level of complexity of the given service request is due to one or more properties of a location associated with the given service arrangement.

In some implementations, the service-specific information includes location information for at least one of the respective requester device and the respective provider device. Alternatively and/or in addition, in various implementations, the service-specific information may include one or more of: distance information between two locations associated with the given service request, traffic information corresponding to one or more locations associated with the given service request, telematics information obtained by one or more sensors of at least one of the respective requester device and the respective provider device, one or more historical communications between a requester device and provider device in the geo-fence of the locations associated with the given service request, one or more prior communications between the respective requester device and the respective provider device, or other service-specific information, including other contextual information regarding the given service request.

According to some examples, the synthetic message is generated using a message template that includes a contextual variable. The contextual variable is determined based on the service-specific information for the given service request. Generating the synthetic message includes calculating the contextual variable based on the service-specific information for the given service request.

Still further, in other examples, the network computer system analyzes a plurality of communications sent between the plurality of requester computing devices and the plurality of service provider computing devices. The network computer system further identifies a contextual feature from the plurality of communications by applying one or more machine learning techniques. When the network computer system detects the trigger, it detects the contextual feature in the service-specific information. In some implementations, the contextual feature may be associated with a key phrase, and the synthetic message generated in response to detecting the trigger may include the key phrase corresponding to the contextual feature.

Among other benefits, examples as described improve the accuracy and speed of communication between requesters and providers. More specifically, examples as described can significantly increase coordination between requesters and providers of on-demand services. Increased coordination may be due to one or more factors such increased communication regarding a service arrangement, increased speed of communications, increased accuracy of communications, detection of scenarios that benefit from coordination, improved user experience, efficient use of device resources (including time, display area, and other computing resources that are occupied when a user manually composes a communication), and other factors. Such factors lead to benefits which may include, for example, increased service arrangement completion, increased service quality, increased user satisfaction, increased efficiency, and other benefits.

As used herein, a client device, a computing device, and/or a mobile computing device refer to devices corresponding to desktop computers, cellular devices or smartphones, laptop computers, tablet devices, etc., that can provide network connectivity and processing resources for communicating with a service arrangement system over one or more networks. In another example, a computing device can correspond to an in-vehicle computing device, such as an on-board computer. Also, as described herein, a user can correspond to a requester of a network service (e.g., a rider) or a service provider (e.g., a driver and/or a vehicle) that provides location-based services for requesters.

Still further, examples described relate to a variety of location-based (and/or on-demand) services, such as a transport service, a food truck service, a delivery service, an entertainment service, etc., to be arranged between requesters and service providers. In other examples, the system can be implemented by any entity that provides goods or services for purchase through the use of computing devices and network(s). In examples described, the service arrangement system can correspond to a transport arrangement system that arranges transport and/or delivery services to be provided for riders by drivers of vehicles who operate service applications on respective computing devices.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

In the following description, for the purpose of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other does not imply an ordering, timing, or any other characteristic of the referenced items unless otherwise specified; the term “and/or” as used herein refers to and encompasses any and all possible combinations of one or more of the associated listed items; that the terms “comprises” and/or “comprising” specify the presence of stated features, but do not preclude the presence or addition of one or more other features.

### System Overview

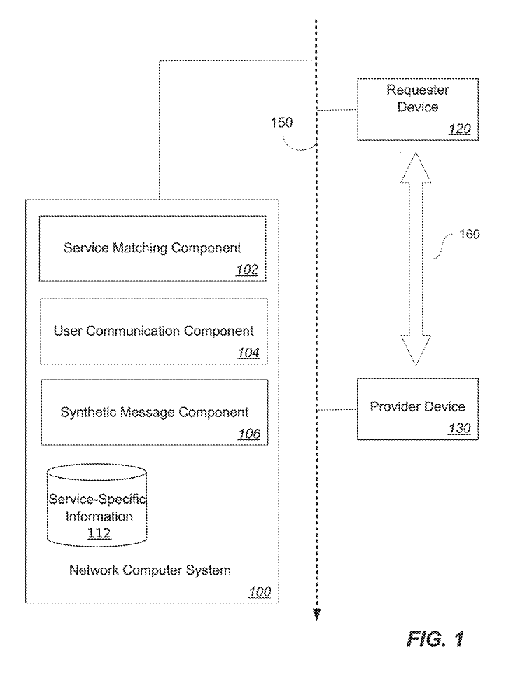

FIG. 1 illustrates an example network computer system to generate synthetic messages based on service-specific information. A network computer system 100 such as that shown in FIG. 1 can be implemented in a variety of computing environments, including as part of a network service provided through one or more servers. In some variations, the network computer system 100 is implemented as part of, or in connection with a service arrangement system, where the service arrangement system matches service requests from requesters with service provider entities. For example, the service requests may correspond to on-demand transportation service requests, on-demand delivery service request, and/or other service requests. Still further, some examples provide for the network computer system 100 to be distributed using one or more servers and/or mobile devices.

The network computer system 100 may be implemented on a server, on a combination of servers, and/or on a distributed set of computing devices which communicate over a network 150, such as the Internet. In some examples, the network computing system 100 is implemented using mobile devices of users, including provider devices and requester devices, with the individual mobile devices each executing a corresponding service application that causes the respective mobile device to operate as an information inlet and/or outlet for the network computing system 100.

In some examples, the network computer system 100 includes a service matching component 102. The service matching component 102 matches a given service request from a requester device 120 with a provider entity associated with a provider device 130. The provider entity associated with the provider device 130 is assigned to perform the requested service for the user associated with the requester device 120. In examples, a service arrangement involves matching a service provider to a service request, and enabling or otherwise facilitating a service provider to fulfill the matched service request. In some implementations, a user can participate in a service implemented on the network computer system 100 as either a requester in a first service request and/or a provider in a different service request.

The network computer system 100 communicates with the requester device 120 and the provider device 130 over the network 150. While FIG. 1 is described in context of requester device 120 and provider device 130, network computer system 100 can implement functionality as described with examples of FIG. 1, using devices of requesters and/or providers in a given population of users.

In some implementations, a requester can use requester device 120 to submit a service request to the network computer system 100 over the network 150. The service matching component 102 matches the service request with a service provider entity. In examples, the provider entity is a user that is a service provider. In other variations, the provider corresponds to, or is associated with an autonomous vehicle, or alternatively, with an autonomous entity.

In some examples, the network computer system 100 includes a user communication component 104. The user communication component 104 may enable and/or otherwise manage communication between the requester device 120 and the provider device 130 during a service arrangement. For example, after the service matching component 102 matches the service request submitted by the requester device 120 with the service provider entity associated with the provider device 130, the user communication component 104 may enable or otherwise manage a communication channel 160 between the requester device 120 and the provider device 130.

The communication channel 160 may be established over one or more networks, including network 150 (e.g., the Internet), as well as one or more cellular networks, telephone networks, data networks, and/or other networks. Alternatively and/or in addition, the user communication component 104 may interface with one or more messaging services, such as provided over a data or telephony network. For example, in some implementations, the user communication component 104 may provide a messaging service that communicates messages between the requester device 120 and the provider device 130. In another example, the user communication component 104 may interface with a mobile telephone network to allow communication via text messages.

In some embodiments, the respective users of the requester device 120 and the provider device 130 are provided a communication interface on the respective devices. The communication interface may enable the sending of synthetic messages and/or the composing and sending of user-drafted messages between the requester device 120 and the provider device 130.

### Synthetic Message Overview

In some examples, the network computer system 100 includes a synthetic message component 106. The synthetic message component 106 generates synthetic messages based on service-specific information 112. For example, the synthetic message component 106 may generate a synthetic message for a particular service request that includes custom content for the particular service request. The custom content may be based on service-specific information 112 obtained by the network computer system that corresponds to the particular service request. The custom content in the synthetic message facilitates communication and coordination between the requester device 120 and the provider device 130 with respect to carrying out the service request. Service-specific information is described in greater detail below.

In some examples, a synthetic message has a sender and a recipient. For a particular service request associated with the requester device 120 and the provider device 130, the synthetic message may be from the requester device 120 to the provider device 130, or from the provider device 130 to the requester device 120. In some examples, an option is provided to the sender (e.g., requester device 120 or provider device 130) to send the synthetic message to the recipient (e.g., over communication channel 160 to the respective user device that is the recipient of the synthetic message). Alternatively and/or in addition, one or more synthetic messages may be automatically sent to the respective party.

A communication that includes the synthetic message may be sent over a communication channel 160 from a first device to a second device. In some implementations, when the communication is sent over the communication channel 160, the network computer system 100 (e.g., user communication component 104) handle the communication. For example, the network computer system 100 may receive the communication and/or instructions regarding the communication over the network 150, process the received data, and send an outgoing communication over the network 150 to the second device. Alternatively and/or in addition, the communication that includes the synthetic message may be sent over other messaging infrastructure, including third-party messaging systems, cellular networks, or other telecommunication networks.

### Service-Specific Information Overview

In some examples, the network computer system 100 receives and/or maintains service-specific information 112 for a plurality of service requests. Service-specific information 112 may be used to generate synthetic messages. The service-specific information 112 includes data that describes one or more service requests, including the service request from requester device 120 that is matched to the provider entity associated with provider device 130. The service-specific information 112 may include device data and/or system data, which are described in greater detail hereinafter.

Device data includes data received from a user device (e.g., requester device 120, requester device 130) in association with a service request, such as the service request itself or data received from the user device during the performance of the service request. In some examples, the device data includes sensor information generated by a sensor of a user device. For example, the sensor information may include sensor output data from a location-aware component (e.g., satellite receiver, GPS component), an accelerometer, a gyroscope, magnetometer, camera, microphone, thermometer, barometer and/or other hardware sensors of the user device. Alternatively and/or in addition, the device data may also include information generated by the user device after processing sensor data from one or more sensors. For example, the user device may process sensor data to generate information at the user device, such as location information, orientation information, movement information, speed and/or velocity information, and other information that can be determined from sensor output data. In some implementations, the device data includes information generated by the user device after processing sensor data and other data. For example, a user device may generate device data based on sensor data and other information obtained by the user device, such as data obtained over a network (e.g., weather data, traffic data).

The network computer system 100 may receive the device data from an application executing on the user device, such as a service application that facilitates the requesting and/or performance of the service request. The network computer system 100 may process the device data to manage and/or monitor the service arrangement. In some implementations, the network computer system 100 updates a data store that stores service-specific information 112 when new service-specific information is received from the requester device 120 and the provider device 130 for a particular service request. The synthetic message component 106 may access the data store to obtain the service-specific information 112 for one or more service requests in order to perform one or more functions as described herein. The service specific information 112 may include system data. System data includes data generated at the network computer system 100 in association with a service request. The network computer system 100 may generate system data based on device data from one or more user devices (e.g., requester device 120, provider device 130). In some implementations, the network computer system 100 may generate system data based on data stored in one or more data stores of the network computer system 100, and/or external data obtained from another computer system (e.g., information from a server or a data source that is external to the network computer system). In some implementations, the service-specific information 112 for a particular service request may include service-specific information 112 corresponding to other service requests.

In some implementations, the system data includes related contextual data that is associated with one or more features of a service request. Examples of such related contextual data includes traffic information and/or weather information corresponding to one or more features of the service request. For example, the related contextual data may correspond to a location associated with the service request, a route associated with the service request, an area associated with the service request, a landmark or venue associated with the service request, a time associated with the service request, and/or another feature associated with the service request. Such related contextual data may be obtained from a component of the network computer system 100 and/or from one or more components external to the network computer system 100. For example, weather information for a location associated with a service request may be obtained from a third-party server and/or service over the network 150.

The service-specific information 112 may include one or more service request parameters. Service request parameters include properties that describe the service request. The service request parameters may be included in the service request from the requester device 120, such as a starting location, a destination location, a service vehicle type, a time of the service request, a time that the service is to initiate, and/or other information that may be included in the service request. Service request parameters that are included or otherwise provided with the service request may include parameters selected by a user (requester or provider), parameters automatically determined by the requester device 120 and/or the provider device 130, and/or service parameters determined by the network computer system 100. In some examples, the service request parameters may include one or more properties determined at the network computer system 100. For example, the network computer system 100 may add or update one or more parameters of the service request, such as server-side information about a user, a provider entity that is matched to the service request (e.g., by service matching component 102), server-side information about the provider entity, or other properties determined at the network computer system.

Alternatively and/or in addition, the service-specific information 112 may include service state information. Service state information describes a current state of the performance of the service request. For example, the service state information can indicate that a service request received by the network computer system 100 is (i) not yet matched (e.g., not yet processed by the service matching component 102), (ii) currently being matched (e.g., currently being processed by the service matching component 102), or (iii) matched to a service entity (e.g., by the service matching component 102). Furthermore, when the service request is matched to a service entity, the service state information may indicate that the service entity is: (i) available, (ii) heading to the starting location, (iii) has picked up the requester, (iv) is nearing the destination location, or (v) has reached the destination location. Depending on service type, the service state information can also include whether or not other passengers are in the service entity vehicle.

Alternatively and/or in addition, the service-specific information 112 may include event information. Event information indicates the occurrence of an event and/or properties of the event. A user device (e.g., requester device 120, provider device 130) may generate event information based on device data at the user device before communicating the event information to the network computer system 100. For example, when the device data of provider device 130 indicates that the location of the provider device 130 is at a destination location associated with the service request, the provider device 130 may transmit event information to the network computer system 100 indicating an arrival event. As another example, an application executing on the user device may process sensor data and/or other device data at the user device to determine the occurrence of an event. For example, based on location information at the requester device 120, the requester device 120 may determine that the requester has moved away from the starting location corresponding to the service request and transmit event information to the network computer system 100 to the occurrence of the user activity.

In some implementations, an application executing on a requester device 120 evaluates device data at the requester device 120 to detect requester activity or other events involving the requester. The application then generates and transmits requester-generated event information to the network computer system 100. Examples of events involving the requester include, for example, movement of the requester device relative to a starting location (e.g., moving away from the starting location, moving across the street), requester interaction with the requester device 120, and/or requester movement relative to the road (e.g., moving toward the curb, moving indoors).

In some implementations, an application executing on a provider device 130 evaluates device data at the provider device 130 to detect provider activity or other events involving the provider. The application then generates and transmits provider-generated event information to the network computer system 100. The provider device 130 can generate event information based on provider device data that reflects requester activity. Examples of events involving the provider include, for example, (i) provider interaction with the provider device 130 (e.g., provider interacting with an application or moving the device in a particular manner within the vehicle), (ii) provider progress on a route associated with a service request (e.g., provider pulling over, provider deviation from the route), and/or (iii) provider approach information to a starting location associated with the service request (e.g., provider approach from a particular direction or side or the street relative to the starting location).

In some implementations, the event data includes system-generated event information generated by the network computer system 100. For example, when the network computer server 100 obtains traffic information indicating a new accident or other delay on a route associated with a service request, the network computer system 100 may generate event information indicating the occurrence of the new delay on the route. As another example, the network computer system 100 may determine that multiple active service requests have starting locations that are in close in proximity and time. In this case, the network computer system 100 may generate event information corresponding to this occurrence.

Alternatively and/or in addition, the service-specific information 112 may include user information. User information includes data maintained by the network computer system 100 that describes one or more users. User information may be maintained for requester users and/or provider user. In some examples, user information includes user profile information supplied by the user, such as the user's demographic information and/or the user's preferences. Alternatively and/or in addition, the user information may include a user's history that is generated based on one or more other service requests associated with the user. For example, a user's rating, reliability, completion rate, timeliness, and/or other properties may be maintained over multiple service requests associated with the user.

Alternatively and/or in addition, the service-specific information 112 may include prior communication information. For example, the service-specific information 112 for a particular service request may include one or more prior communications between a requester device 120 and a provider device 130 that are associated with the particular service request. In some implementations, the prior communication information may describe communication preferences and/or patterns for one or more users (e.g., requester device 120, provider device 130) associated with the service request. Such patterns and preferences may include patterns and preferences indicated by the respective user or learned by the network computer system 100 from communications involving the respective user in other service requests.

The synthetic message component 106 may evaluate service-specific information 112, including service-specific information as described above, to determine whether a synthetic message is to be generated for a particular service request. For example, the synthetic message component 106 may evaluate the service-specific information to detect one or more triggers, as described in greater detail below.

### Trigger Overview

The synthetic message component 106 may generate a synthetic message corresponding to a service request in response to the detection of a trigger with respect to the service request. A trigger may correspond to a set of predetermined conditions for generating a synthetic message. For example, a trigger may be a set of one or more event types, state changes, features, or other conditions relating to a service request. In some implementations, triggers are detected based on service-specific information 112. When the set of one or more conditions are met with respect to a service request, the synthetic message component 106 generates a synthetic message for the service request.

In some examples, the synthetic message component 106 detects multiple types of triggers. The synthetic message component 106 may generate the synthetic message based on the type of trigger detected. Thus, depending on the set of one or more conditions that are detected, the synthetic message component 106 can generate a custom message that facilitates performance of the service request in a manner that corresponds to the trigger.

For example, a trigger may include the condition that an arrival or near-arrival event occurs, such as the provider device 130 approaching a location associated with the service request. In this case, after the synthetic message component 106 detects the trigger, the synthetic message component 106 may generate a synthetic message from the provider device 130 to the requester device 120 that asks the requester to prepare for the arrival.

In some implementations, the trigger may include multiple conditions. For example, the trigger may include the conditions that (i) the provider device 130 is approaching a starting location for the service request, (ii) the provider device 130 is on the same street as the starting location, (iii) the provider device 130 is traveling east-bound on the street, and (iv) the requester device 120 and the starting location is on the north side of the street. In such an example, after the synthetic message component 106 detects the trigger, the synthetic message component 106 may determine that it is desirable (e.g., more efficient, less likely to cause failure) for the requester to be picked up on the south side of the street rather than the north side of the street to avoid a U-turn. The synthetic message component may also evaluate other conditions, such as whether traffic is heavy or where a legal U-turn can be made. The synthetic message component 106 may then generate a synthetic message from the provider device to the requester device 120 that asks the requester to cross the street to the south side to prepare for the arrival. In some examples, the network computer system 100 may confirm with the provider device 130 before sending the synthetic message to the requester device 120.

In some implementations, the trigger for the synthetic message can include a condition that the given service request is associated with a higher level of complexity. For example, the higher level of complexity may be due to one or more current conditions at a location associated with the given service request, such as increased traffic, increased service requests in the area, and the like. In some implementations, the synthetic message component 106 evaluates temporal information, such as historical patterns (e.g., holidays, day of week, time of day), scheduled event information at a venue (e.g., amphitheater, convention center, sports arena), and the like. A service request may also have a higher level of complexity due to one or more properties of a location associated with the given service arrangement. For example, if a location associated with the given service arrangement has previously had a lower completion rate or a high-level service request delays, then the given service arrangement may be deemed to have a higher level of complexity.

Still further, the trigger for the synthetic message can be generated in response to a particular condition detected from a sensor or other resource of the respective requester or provider devices 120, 130. By way of example, the location-aware resource of the requester or provider device may be unable to determine a pinpoint location of the user (e.g., requester is standing on an underpass or overpass road). According to examples, when such a condition is detected, the synthetic message component 106 generates a synthetic message that includes a predetermined content. For example, the predetermined content may notify the user of the condition (e.g., “Your location is unknown right now.”) and/or prompt the user to take an action (e.g., “Move towards the street” or “Stand near a [landmark].”). In variations, the synthetic message component 106 can also generate a synthetic message for the other party. For example, the predetermined content may notify a provider that the requester is in a location where the requester device 120 is unable to pinpoint its location.

In some implementations, the trigger is based on detecting a feature that is determined based on analysis of communications sent between requester devices and provider devices in one or more service requests other than the given service request. For example, the network computer system 100 may determine that, for previous service requests that are associated with a particular starting location, multiple communications between service providers and requesters included the phrase “red garage” before the respective service provider arrives at the particular starting location. The network computer system 100 may also determine that the usage of the phrase “red garage” improves one or more metrics related to performance of the service request, such as reduced delays, increased service completion, and the like. Based on this information, the network computer system 100 may create a trigger that associates a feature or condition (e.g., the particular starting location) and a phrase (e.g., “red garage”). When the synthetic message component 106 detects this trigger for a given service request (e.g., detects that a given service request is associated with the starting location), the synthetic message component 106 may generate a synthetic message for the given request. For example, the synthetic message may include the phrase (e.g., a message from the requester device 120 to the provider device 130: “I'll be waiting at the red garage”). The network computer system 100 may confirm with the requester device 120 before sending the synthetic message to the provider device 130.

### Example System

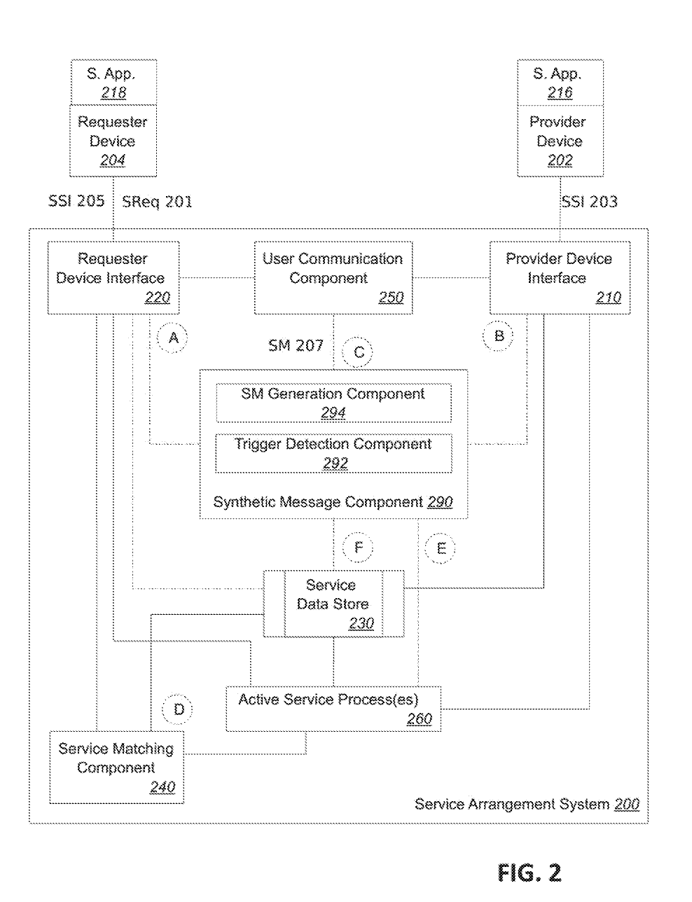

FIG. 2 illustrates an example of a service arrangement system which manages the generation of synthetic messages based on service-specific information. According to examples, a service arrangement system 200 may be implemented as a network service, using, for example, a network computer system 100 such as described in FIG. 1. In some examples, the service arrangement system 200 implements a network platform in connection with applications that run on mobile devices of the population of users. In variations, the types of services which may be arranged through the service arrangement system 200 may include human transport, deliveries, shipping, deliver, and other on-demand services. For a given geographic region, the users can include operators (or “service providers”) of service vehicles, as well as requesters who receive a transport-related service. The service arrangement system 200 may include a provider device interface 210, a requester device interface 220, a service matching component 240, a user communication component 250, and a synthetic message component 290.

The provider device interface 210 includes or performs processes that run on the network-side of the service arrangement system 200 to establish communication channels with individual devices of service providers. For example, the provider device interface 210 can establish secure sockets with different types of mobile devices. The service providers of the service arrangement system 200 can utilize these secure sockets when providing services using their respective vehicles. In some examples, the service providers operate mobile devices (represented in FIG. 2 by the provider device 202) on which a corresponding service application 216 runs. The service application 216 may correspond to a program (e.g., a set of instructions or code) that is downloaded and stored on the provider device 202. The service provider can launch the service application 216 on the provider device 202 in order to utilize the service arrangement system 200 to receive service requests, and the service provider may operate a service vehicle to fulfill assigned service requests. Among other functionality, the service application 216 can automate operations which include sending information (including service-specific information 203) to the service arrangement system 200 and receiving information from the service arrangement system 200 that facilitates providing the services to requesters.

Likewise, the requester device interface 220 includes or performs processes that run on the network-side of the service arrangement system 200 to establish communication channels with individual devices of requesters. The requesters may also operate mobile devices (represented in FIG. 2 by the requester device 204) on which a corresponding service application 218 runs. The service application 218 may correspond to a program (e.g., a set of instructions or code) that is downloaded and stored on the requester device 204. A requester can launch the service application 218 on the requester device 204 in order to utilize the service arrangement system 200. The requesters may operate respective service applications 218 to request transport-related services, such as human transport between a starting location (or pickup location) and a destination location (or drop-off). Among other functionality, the service application 216 can automate operations which include sending information (including service-specific information 205) to the service arrangement system 200 and receiving information from the service arrangement system 200 that facilitates requesting and receiving services provided by service providers.

In some examples, the provider device interface 210 and the requester device interface 220 can each include or use an application programming interface (API), such as an externally provider-facing API, to communicate data with the provider device 202 and requester devices 204, respectively. By providing the externally facing API, the service arrangement system 200 can establish secure communication channels via secure access channels over the network through any number of methods, such as web-based forms, programmatic access via RESTful APIs, Simple Object Access Protocol (SOAP), remote procedure call (RPC), scripting access, etc.

The requester device interface 220 sends and receives information from requester devices 204. For example, the requester device interface 220 may receive a service request 201 from a requester device 204, and service-specific information 205 that relates to the service request 201. The service-specific information 205 from the requester device 204 may include information that is generated for a specific service arrangement, such as the service request 201 that requests the specific service arrangement, requester-generated device data, requester-generated event information, communications sent from the requester device 204, and other information generated for a specific service arrangement. The service-specific information 205 may also include information generated by the requester device 204 that is not specifically generated for the particular service request 201 but which relates to the requester of the particular service request 201. For example, such information may include but is not limited to identification information for the requester device 204 or for a requester using the requester device 204, hardware or software specifications for requester device 204, and/or device data generated at the requester device 204 before the service request 201

The provider device interface 210 sends and receives information from provider devices 202. For example, the provider device interface 220 may receive information indicating that a provider device 202 is active, send information regarding an assigned service request 201, and receive service specific-information 203 corresponding to the assigned service request 201. The service-specific information 203 from the provider device 202 may include information that is generated for a specific service arrangement (e.g., the service arrangement corresponding to the assigned service request 201), provider-generated device data, provider generated event information, communications sent from the provider device 202, and other information generated for the specific service arrangement. The service-specific information 203 may also include information generated by the provider device 202 that is not specifically generated for the particular service request 201 but relates to the service provider assigned to the particular service request 201. For example, such information may include identification information for the provider device 202 or for a service provider using the provider device 202, hardware or software specifications for provider device 202, device data generated at the provider device 202 before the service request 201 is assigned.

According to some examples, the provider device 202 initiates communications with the service arrangement system 200 using the service application 216 to indicate that the service provider associated with the provider device 202 is available. When a service provider is available, the service provider can receive and fulfill assigned service requests. The service arrangement system 200 may maintain information regarding available service providers and/or available provider devices 202. For example, a service state of a service provider can be available or unavailable, or another state which reads on availability (e.g., online, offline, busy, free, on route to starting location, on service route to destination location, etc.).

The service matching component 240 matches a service request 201 (and/or corresponding requester, requester device 204) with an available service provider (and/or corresponding provider device 202). In addition to the availability of the service provider, the service matching component 240 may determine a match based on one or more properties of the service provider and/or the requester, such as, for example, location, preferences, proximity, type of service, and/or context. Once the service provider 202 is matched to the service request 201, the service matching component 240 may change the service state associated with the selected service provider. For example, a service state of the service provider can be changed from available to unavailable, or from available to on route to the starting location associated with the service request.

After the service matching component 240 matches the service request between the requester device 204 and the provider device 202, the service arrangement system 200 manages and/or monitors the service arrangement. For example, the service arrangement system 200 may perform management and monitoring activities based on service-specific information from the provider device 202 and the requester device 204. The provider device interface 210 may receive provider-generated service-specific information 203 from the provider device, and the requester device interface 220 may receive requester-generated service-specific information 205 from the requester device 204. After the service arrangement system 200 receives the service-specific information 203-205 at the provider device interface 210 and the requester device interface 220, the service-specific information 203-205 may be stored (e.g., by updating the service data store 230) and/or further processed. For example, the service-specific information 203-205 may be processed by the service matching component 240, the synthetic message component 290, and/or one or more active service processes 260 of the service arrangement system that are configured to monitor and/or manage the service request.

In some implementations, the service arrangement system 200 includes a service data store 230. The service data store 230 includes data that describes one or more service requests, such as service-specific information 203-205 for service request 201. The service data store 230 may include one or more tangible and/or virtual data storage locations, which may or may not be physically co-located. By way of example, the service data store 230 may include text or alphanumeric data maintained in memory and/or on disk. As another example, the data store can include a database maintained by a database server. The service data store 230 may include service request parameters, service-state information, event information, user information, prior communication information and other contextual information associated with one or more service requests such as service request 201.

The service-specific information in the service data store 230 may include provider-generated information (e.g., data generated at the provider device 202), requester-generated information (e.g., data generated at the requester device 204), and/or system-generated system (e.g., data generated at the service arrangement system 200). Storing data in the service data store 230 may include adding one or more new data records, updating existing data record/s, and/or appending one or more existing data records. For example, in response to receiving service-specific information 203 from the provider device 202, the provider device interface 210 may cause the service-specific information 203 (or information generated based on the service-specific information 203) to be stored in the service data store 230. Likewise, in response to receiving service-specific information 205 from the requester device 204, the requester device interface 220 may cause the service-specific information 205 (or information generated based on the service-specific information 205) to be stored in the service data store 230. Furthermore, in some embodiments, when service-specific information is generated by one or more components of the service arrangement system 200 (such as the service matching component 240, one or more active service processes 260, and/or the user communication component 250), the server-generated information may be stored in the service data store 230. The synthetic message component 290 may access the service data store 230 to perform one or more functions as described by various examples, including detecting triggers and/or generating synthetic messages.

The synthetic message component 290 of the service arrangement system 200 generates synthetic messages to facilitate communication and coordination of service requests, such as between the requester device 204 and the provider device 202 with respect to carrying out service request 201. For example, the synthetic message component 290 may generate a synthetic message 207 for a service request 201 in response to detecting a trigger based on service-specific information for the service request 201 (e.g., service-specific information 203, service-specific information 205, and/or other service-specific information relating to the service request 201).

In some implementations, the synthetic message component 290 includes a trigger detection component 292 that detects triggers based on service-specific information associated with individual service requests 201. The synthetic message component 290 may also include a synthetic message generation component 294 that generates synthetic messages 207 for individual service requests 201 based on service-specific information associated with the individual service requests 201. The synthetic message component 290 may forward the synthetic message 207 to the user communication component 250, the requester device interface 220, and/or the provider device interface 210 to facilitate performance of the service request 201.

The synthetic message component 290 (including the synthetic message generation component 294 and/or the trigger detection component 290) may obtain service-specific information from a service data store 230 of the service arrangement system 200. Alternatively and/or in addition, the synthetic message component 290 may obtain service-specific information from one or more other components of the service arrangement system 200. For example, the synthetic message component 290 may obtain data from components of the service arrangement system such as (A) a requester device interface 220, (B) a provider device interface 210, (C) a user communication component 250, (D) a service matching component 240, (E) one or more active service processes 260, (F) a service data store 230, (G) a user profile data store, or another component of the service arrangement system. The dashed lines in FIG. 2 illustrate, without limitation, example sources from which the synthetic message component 290 can obtain service-specific information to perform one or more functions as described herein.

In some implementations, the service arrangement system 200 includes a user communication component 250. The user communication component 250 may enable and/or otherwise manage communication between the requester device 204 that submits a service request 201 and the provider device 202 that is matched thereto. For example, the user communication component 250 may enable or otherwise manage a communication channel between the requester device 204 and the provider device 202 over one or more networks, including network 150 (e.g., the Internet), one or more cellular networks, telephone networks, data networks, and/or other networks. In some implementations, after the synthetic message generation component 294 generates a synthetic message 207 for the service request 201, the user communication component 250 receives the synthetic message 207 from the synthetic message component 290 and handles the synthetic message 207. For example, the user communication component 250 may present the synthetic message 207 to the sender for confirmation and/or transmit the synthetic message 207 to the receiver.

### Message Template

In some implementations, synthetic messages are generated using one or more message templates. In some examples, a particular trigger (e.g., set of conditions) may be associated with a particular message template. When the particular trigger is detected based on the service-specific information for a given service request, the contextual variable is determined using the service-specific information, and a synthetic message is generated for the given service request using the contextual variable.

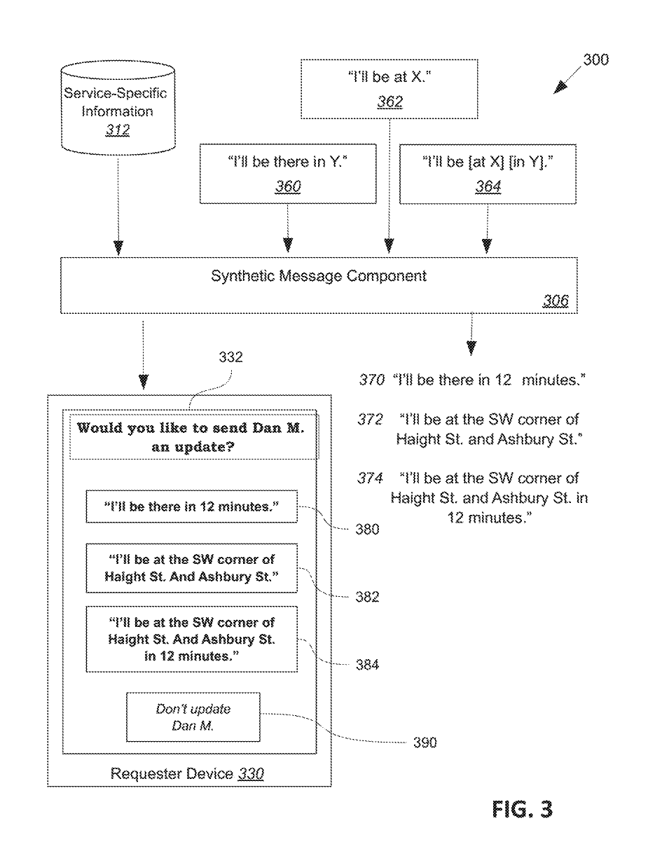

FIG. 3 illustrates example generation of synthetic messages using a message template. Service arrangement system 300 includes synthetic message component 306. The synthetic message component 306 detects a trigger, the synthetic message component 306 may generate one or more synthetic messages using a message template, such as message template 362, message template 362 and/or message template 364.

Message template 360 is a message template that includes a contextual variable Y that represents a time duration. When the synthetic message component 306 detects the corresponding trigger in association with a given service request, it can determine a value for the contextual variable Y based on the service-specific information 312 associated with the given service request. In the illustrated example, the value for the contextual variable is “12 minutes” (representable as text, a numerical value, or another value that is convertible to text). The synthetic message component 306 may use Y and the message template 360 to generate synthetic message, “I'll be there in 12 minutes.”

Message template 362 is a message template that includes a contextual variable X that represents a location. When the synthetic message component 306 detects the corresponding trigger, it can determine the contextual variable X based on the service-specific information 312. In the illustrated example, the value for the contextual variable is “the SW corner of Haight St. and Ashbury St.” (representable as text or another representation that is convertible to text). The synthetic message component 306 may use X and the message template 362 to generate synthetic message 372, “I'll be at the SW corner of Haight St. and Ashbury St.”

Message template 364 is a message template that includes a contextual variable X that represents a location and a contextual variable Y that represents a time duration. When the synthetic message component 306 detects the corresponding trigger, it can determine the contextual variable X and the contextual variable Y based on the service-specific information 312. The synthetic message component 306 may X, Y and the message template 364 to generate synthetic message 374, “I'll be at the SW corner of Haight St. and Ashbury St. in 12 minutes.”

In some examples, the synthetic message component 306 can generate multiple synthetic messages for a set of service-specific information. For example, the synthetic message component 306 may detect one or more triggers that cause the generation of each of the illustrated synthetic messages 370-374 using all of the illustrated message templates 360-364. In some of the one or more synthetic messages 370-374 to be sent to the corresponding recipient device.

### Machine Learning

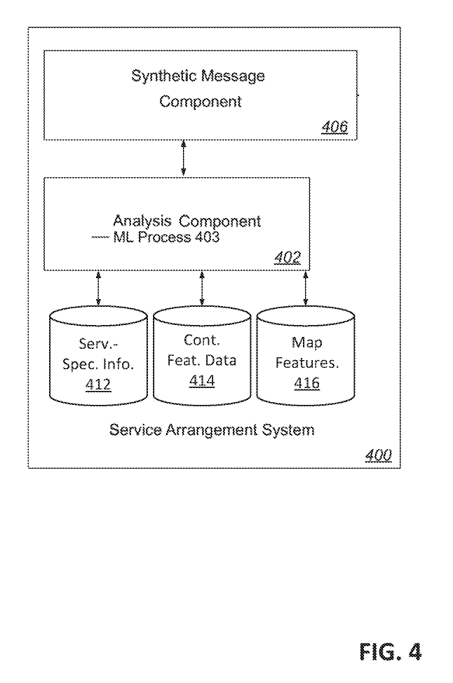

In some implementations, a service arrangement system uses machine learning to generate synthetic messages. FIG. 4 illustrates an example service arrangement system that generates synthetic messages based on service-specific information using machine learning.

A service arrangement system 400 may include a synthetic message component 406 and an analysis component 402. The analysis component 402 analyzes service-specific information 412 identified from service requests made of the system 400 over a given time period. The system 400 can identify contextual features from the service-specific information 412 that are relevant to generating synthetic messages, using one or more machine learning processes 403.

In this manner, the synthetic message component 406 can be configured to implement logic (e.g., rules) to generate synthetic messages based on contextual features identified from events related to service requests that are in progress of being fulfilled. For example, the analysis component 402 may identify contextual features and store the contextual feature data 414 for use by synthetic message component 406 to generate synthetic messages. In some examples, the synthetic message component 406 can detect one or more triggers that are based on contextual feature data 414.

For example, the analysis component 402 may analyze communications sent between requester devices and provider devices in association with a plurality of service requests. In some examples, the analysis component 402 may identify a phrase that appears in communications when certain contextual features are present in service requests. In an example described above, the phrase “red garage” appears in communications in association with a particular starting location for service requests. In some implementations, a analysis component 402 identifies this association by applying machine learning techniques to service-specific information 412 that includes communications between requester devices and provider devices.

The analysis component 402 may create one or more conditions and/or triggers based on the contextual features that appear in association with the phrase. This contextual feature data 414 is then used by the synthetic message component 406 to generate synthetic messages. For example, when the synthetic message component 406 detects the trigger that is created based on the machine learning technique/s, the synthetic message component 406 may generate a synthetic message that includes the phrase associated with the trigger. In the example of the phrase “red garage”, the analysis component 402 may determine conditions when the phrase “red garage” improves performance of service requests, and create a trigger to leverage this performance improvement when the conditions occur in subsequent requests.

In some variations, the analysis component 402 can implement the machine learning processes 403 to refine identification of contextual features that form the basis of triggers or conditions for generating synthetic messages. The machine learning processes 403 can also use contextual information to develop timing parameters and conditions for when individual synthetic messages are to be generated, separate from the triggers for the respective synthetic messages. For example, analysis component 402 can process service-specific information 412 to identify contextual features that are triggers (or potential triggers) for generating a synthetic message that has a particular content or is otherwise likely to cause a particular outcome (e.g., when received by the requester or provider). Additionally, analysis component 402 can process service-specific information 412 to determine timing parameters and conditions for when individual synthetic messages are to be generated, separate from other contextual features that are triggers for the respective synthetic messages. For example, analysis component 402 can learn that a particular contextual feature (e.g., requester standing away from curb) is a good trigger for generating a particular synthetic message for the requester or provider, but the analysis component 402 can also learn timing parameters and/or conditions for queuing the synthetic message until a moment that will likely cause the use of the synthetic message to have the most desired outcome. The synthetic message component 406 can, for example, use learned timing parameters and conditions to queue a synthetic message until a particular timing condition is met (e.g., when vehicle is within a threshold distance). Once the timing parameter or condition is met, the synthetic message component 406 can generate the synthetic message for the appropriate party (e.g., compose message for provider, “Arriving now, can you stand by the curb?” for transmission to recipient, or deliver composed message to recipient). Thus, analysis component 402 can develop and implement machine learning processes 403 to determine timing (e.g., at least x seconds before vehicle reaches pickup location) and/or other conditional parameters (e.g., state of service request, such as provider approaching requester in vehicle) to promote creation and/or delivery of the synthetic message at a time that is deemed most relevant or appropriate.

According to examples, the synthetic message component 406 can be configured with logic (e.g., rules) to identify triggers, as well as timing parameters and conditions for respective triggers. The analysis component 402 can further analyze service-specific information 412 to update the logic implemented by the synthetic message component 406. In particular, the analysis component 402 can update the logic implemented by the synthetic message component 406 by monitoring an outcome of synthetic messages generated by the synthetic message component 406. For example, the analysis component 402 can determine whether (i) a composed synthetic message was used by a sender, (ii) when the composed synthetic message was sent by the sender, and/or (iii) whether an outcome of the transmitted synthetic message was desired (e.g., caused a recipient of the message to perform a desired action) or in furtherance of an objective (e.g., reducing time vehicle waits at curb). The monitored outcome can be used to vary, for example, the trigger, timing parameter or other condition for a synthetic message.

The analysis component 402 can also process the service-specific information 412, generated with respect to service requests that are in progress of being fulfilled, to correlate contextual features to geographic locations where events relevant to the respective contextual features took place. For example, contextual information can be correlated to a coordinate (e.g., longitude and latitude) or a set of coordinates (e.g., city block, intersection), where an underlying event occurred with respect to fulfillment of a particular service request. The analysis component 402 can store map feature data 416 to store correlations between contextual data and geographic data.

The analysis component 402 can also detect replies and/or feedback to synthetic messages. The analysis component 402 can use map feature data 416 to correlate reply messages and/or feedback to corresponding geographic locations based on, for example, the geographic correlations of the corresponding triggers of the original synthetic messages. In some examples, the analysis component 402 can parse, or otherwise process replies and/or feedback to identify information about a particular geographic location. For example, content or other analysis can be performed on reply messages and feedback to determine a location-specific trigger or condition. The location-specific trigger or condition can be correlated to, for example, a specific content that is also derived from feedback or reply messages (e.g., “Flooding in the area.”). Still further, map features can be altered to reflect a location-specific condition, as detected by feedback or reply messages.

### Example Processes

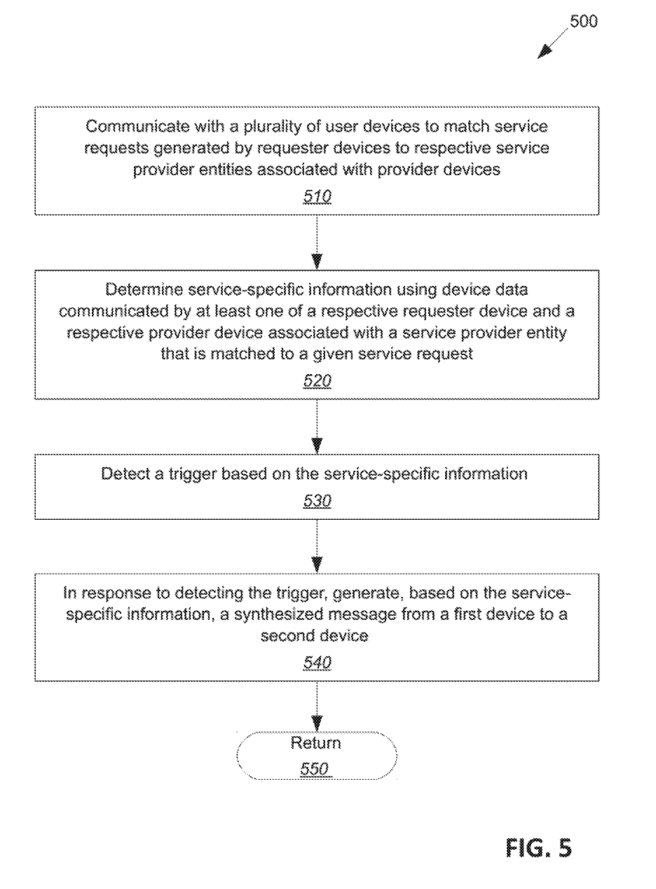

FIG. 5 illustrates is a flow diagram of an example process for generating synthetic messages based on service-specific information. In describing an example of FIG. 5, reference may be made to elements described with other figures for purpose of illustrating a suitable component or element for performing a step or sub-step being described.

Process 500 may be performed by one or more computing devices and/or processes thereof. For example, one or more blocks of process 500 may be performed by network computer system 100. In one embodiment, one or more blocks of process 400 are performed by a service arrangement system executing on a computing system, such as service arrangement system 200. Process 500 will be described with respect to service arrangement system 200, but is not limited to performance by service arrangement system 200.

At block 510, the service arrangement system 200 communicates with a plurality of user devices to match service requests generated by requester devices to respective service provider entities associated with provider devices. The plurality of user devices includes a plurality of requester devices and a plurality of provider devices. In some implementations, the service arrangement system matches on-demand service requests with service provider entities, such as on-demand service requests for transportation services and/or delivery services.

At block 520, the service arrangement system 200 determines service-specific information using device data communicated by at least one of a respective requester device and a respective provider device associated with a given service request. In some examples, the given service request originates from the respective requester device, and the respective provider device is associated with a service provider entity that the service arrangement system 200 matches to the given service request. In some examples, the service arrangement system 200 collects service-specific information for a plurality of service requests that includes the given service request.

The service-specific information may include device data generated at the respective requester device and/or the respective provider device associated with the given service request, such as location information, telematics information obtained by one or more sensors, other sensor-generated information, and other device data generated or collected at the respective device. Alternatively and/or in addition, the service-specific information may include other information associated with the given service request, such as information (e.g., traffic information) corresponding to one or more locations associated with the given service request, areas or routes associated with the given service request, one or more prior communications between the respective requester device and the respective provider device, or other service-specific information, including other contextual information. In some examples, the service-specific information includes information that describes a service state of the given service request.

At block 530, the service arrangement system 200 detects a trigger based on the service-specific information. In some examples, detecting the trigger is based on at least one of the respective requester device and the respective provider device approaching a location associated with the given service request. In some implementations, detecting the trigger is based on detecting a feature that is determined based on analysis of communications sent between requester devices and provider devices in one or more service requests other than the given service request. In some implementations, detecting the trigger is based on determining that the given service request is associated with a higher level of complexity, such as due to one or more properties of a location associated with the given service request.

In some implementations, the trigger is based on a contextual feature that is identified using one or more machine learning techniques. For example, the service arrangement system 200 may analyze a plurality of communications for a plurality of service requests and use one or more machine learning techniques to identify a key phrase corresponding to a contextual feature from the plurality of communication.

At block 540, in response to detecting the trigger, the service arrangement system 200 generates, based on the service-specific information, a synthetic message from a first device to a second device. The first device is one of the respective requester device and the respective provider device. The first device potentially sends of the synthetic message, while the second device is the other device that potentially receives is the synthetic message. In some implementations, the service arrangement system 200 generates the synthetic message using a message template that includes a contextual variable that is determined based on the service-specific information. The contextual variable is calculated based on the service-specific information. In some embodiments, the service arrangement system 200 further causes a communication comprising the synthetic message to be transmitted to the second device.

At block 550, process 500 returns and/or terminates. For example, process 500 may pass control to a calling process, generate any appropriate record or notification, return after a method or function invocation, perform an operation on the generated synthetic message, perform an operation that causes the generation of a synthetic message based on server-specific information, perform another operation, or terminate.

### Hardware Overview

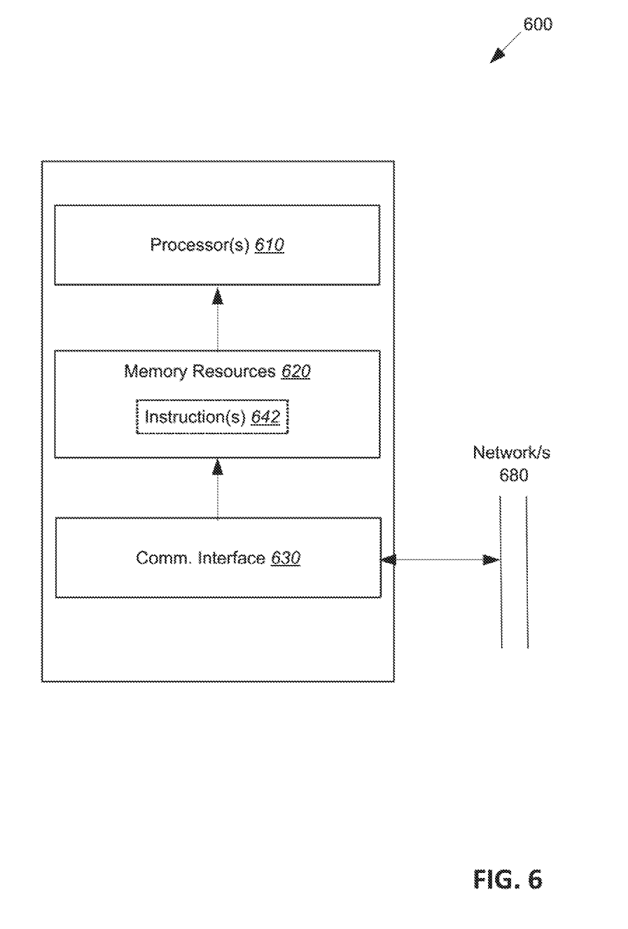

FIG. 6 illustrates a block diagram that illustrates a computer system on which examples described herein may be implemented. For example, in the context of FIG. 1 and FIG. 2, network computer system 100 and/or service arrangement system 200 may be implemented using a computer system or combination of computer systems, such as described by FIG. 6.

In one implementation, the computer system 600 includes one or more processors 610, memory resources 620, and a communication interface 630. The computer system 600 includes at least one processor 610 for processing information. The memory resources 620 may include a random access memory (RAM) or other dynamic storage device, for storing information and instructions to be executed by the processor(s) 610. The memory resources 620 also may be used for storing temporary variables or other intermediate information during execution of instructions to be executed by the processor(s) 610. The computer system 600 may also include other forms of memory resources, such as static storage devices for storing static information and instructions for the processor 610. The memory resources 620 can store information and instructions, including instructions 642 for generating synthetic messages based on service-specific information in order to implement, for example, the service arrangement system 200. Additionally, the processor(S) 610 can execute the instructions 642 to implement a method such as the example process 500 described with respect to FIG. 5.

The communication interface 630 can enable the computer system 600 to communicate with one or more networks 680 (e.g., cellular network) through use of the network link (wireless or wireline). Using the network link, the computer system 600 can communicate with one or more other computing devices and/or one or more other servers or data centers. In some variations, the computer system 600 can receive device data and/or service-specific information from provider devices (e.g., provider device 130) and requester devices (e.g., requester device 120) via the network 680 to facilitate generating synthetic messages based on service-specific information in order to implement and other aspects described herein.

Examples described herein are related to the use of the computer system 600 for implementing the techniques described herein. According to one embodiment, those techniques are performed by the computer system 600 in response to the processor 610 executing one or more sequences of one or more instructions contained in the memory resource 620. Such instructions may be read into the memory resources 620 from another machine-readable medium, such as the storage device. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

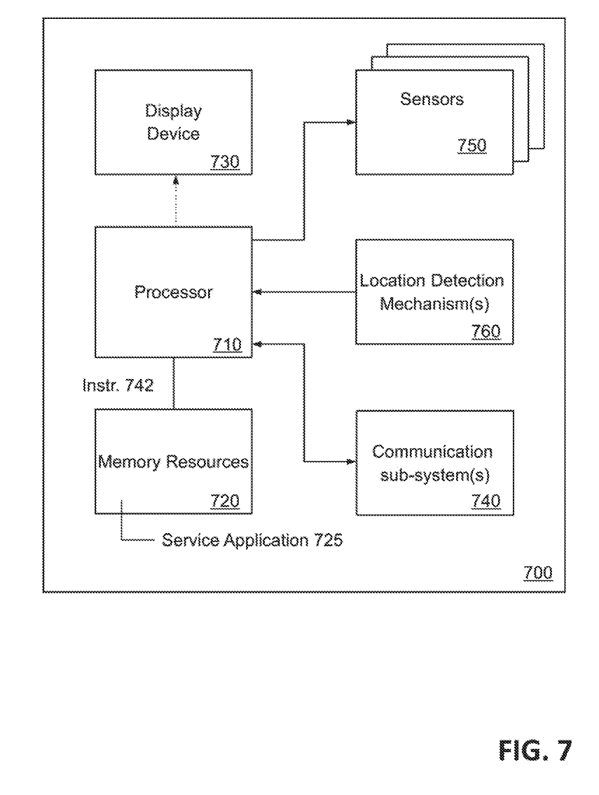

FIG. 7 is a block diagram that illustrates a computing device upon which examples described herein may be implemented. In one embodiment, a computing device 700 may correspond to a mobile computing device, such as a cellular device that is capable of telephony, messaging, and data services. The computing device 700 can correspond to a device operated by a requester (e.g., requester device 120 and/or requester device 204), or, in some examples, a device operated by the service provider that provides location-based services (e.g., provider device 130 and/or provider device 202). Examples of such devices include smartphones, handsets, tablet devices, or in-vehicle computing devices that communicate with cellular carriers.

The computing device 700 includes a processor 710, memory resources 720, a display device 730 (e.g., such as a touch-sensitive display device), one or more communication sub-systems 740 (including wireless communication sub-systems), one or more sensors 750 (e.g., accelerometer, gyroscope, barometer, altimeter, microphone, camera), and one or more location detection mechanisms (e.g., GPS component) 760. In one example, at least one of the communication sub-systems 740 sends and receives cellular data over data channels and voice channels. The communications sub-systems 740 can include a cellular transceiver and one or more short-range wireless transceivers. The processor 710 can exchange data with a service arrangement system (not illustrated in FIG. 7) via the communications sub-systems 740.

The processor 710 can provide a variety of content to the display 730 by executing instructions stored in the memory resources 720. The memory resources 720 can store instructions for the service application 725. For example, the processor 710 is configured with software and/or other logic to perform one or more processes, steps, and other functions described with mobile computing devices of occupants of vehicles. In particular, the processor 710 can execute instructions and data stored in the memory resources 720 in order to execute a service application, such as described with various examples. In one example, the processor 710 may execute instructions 722 to communicate messages, notifications, service-specific information, and other data between the computing device 700 and the service arrangement system 200.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
one or more processors; and
one or more memory resources storing instructions that, when executed by the one or more processors, cause the one or more processors to:
communicate with a plurality of user devices, including a plurality of requester devices and a plurality of provider devices, to match service requests generated by the plurality of requester devices to respective service provider entities associated with the plurality of provider devices;
for a given service request generated by a respective requester device of the plurality of the plurality of requester devices:
(a) determine service-specific information using device data communicated by at least one of (i) the respective requester device and (ii) a respective provider device associated with a service provider entity that is matched to the given service request;
(b) detect a trigger based on the service-specific information;
(c) in response to detecting the trigger, generate, based on the service-specific information, a synthetic message from (i) a first device selected from the respective requester device and the respective provider device to (ii) a second device selected from the respective requester device and the respective provider device.

2. The network computer system of claim 1, wherein the executed instructions cause the one or more processors to cause a communication comprising the synthetic message to be transmitted to the second device.

3. The network computer system of claim 1, wherein the service-specific information includes location information for at least one of the respective requester device and the respective provider device.

4. The network computer system of claim 1, wherein the service-specific information includes distance information between two locations associated with the given service request.

5. The network computer system of claim 1, wherein the service-specific information includes traffic information corresponding to one or more locations associated with the given service request.

6. The network computer system of claim 1, wherein the service-specific information includes telematics information obtained by one or more sensors of at least one of the respective requester device and the respective provider device.

7. The network computer system of claim 1, wherein the service-specific information includes one or more prior communications between the respective requester device and the respective provider device.

8. The network computer system of claim 1, wherein detecting the trigger is based on at least one of the respective requester device and the respective provider device approaching a location associated with the given service request.

9. The network computer system of claim 1, wherein detecting the trigger is based on determining that the service agreement is associated with a higher level of complexity.

10. The network computer system of claim 9, wherein the higher level of complexity is due to one or more current conditions at a location associated with the given service request.

11. The network computer system of claim 9, wherein the higher level of complexity is due to one or more properties of a location associated with the given service request.

12. The network computer system of claim 1, wherein detecting the trigger is based on detecting a feature of the service request that, wherein the feature is determined based on service-specific information from one or more service requests other than the given service request.

13. The network computer system of claim 12, wherein the feature is determined based on analysis of communications sent between requester devices and provider devices for the one or more service requests other than the given service request.

14. The network computer system of claim 1,
wherein the synthetic message is generated using a message template that includes a contextual variable that is determined based on the service-specific information;
wherein generating the synthetic message comprises calculating the contextual variable based on the service-specific information.

15. The network computer system of claim 1, wherein the executed instructions cause the one or more processors to:
analyze a plurality of communications sent between the plurality of requester computing devices and the plurality of service provider computing devices;
identify a contextual feature from the plurality of communications by applying one or more machine learning techniques;
wherein detecting the trigger comprises detecting the contextual feature.

16. The network communication system of claim 15:
wherein the contextual feature includes a key phrase;
wherein the synthetic message generated in response to detecting the trigger includes the key phrase corresponding to the contextual feature.

17. The network computer system of claim 1, wherein the executed instructions cause the one or more processors to provide a communication confirmation feature for display at the first device, wherein the communication confirmation feature is selectable to cause a communication comprising the synthetic message to be transmitted to the second device.

18. The network computer system of claim 17, wherein the executed instructions cause the one or more processors to:
in response to detecting the trigger, generate a second synthetic message based on the service-specific information from the first device to the second device;
provide a second communication confirmation feature for display at the first device, wherein the second communication confirmation feature is selectable to cause a communication comprising the second synthetic message to be transmitted to the second device.

19. A non-transitory computer readable medium storing instructions that, when executed by one or more processors of a network computer system, cause the one or more processors to:
communicate with a plurality of user devices, including a plurality of requester devices and a plurality of provider devices, to match service requests generated by the plurality of requester devices to respective service provider entities associated with the plurality of provider devices;
for a given service request generated by a respective requester device of the plurality of the plurality of requester devices:
(a) determine service-specific information using device data communicated by at least one of (i) the respective requester device and (ii) a respective provider device associated with a service provider entity that is matched to the given service request;
(b) detect a trigger based on the service-specific information;
(c) in response to detecting the trigger, generate, based on the service-specific information, a synthetic message from (i) a first device selected from the respective requester device and the respective provider device to (ii) a second device selected from the respective requester device and the respective provider device.

20. A computer-implemented method of servicing ride requests, the method being performed by one or more processors of a network computer system and comprising:
communicating with a plurality of user devices, including a plurality of requester devices and a plurality of provider devices, to match service requests generated by the plurality of requester devices to respective service provider entities associated with the plurality of provider devices;
for a given service request generated by a respective requester device of the plurality of the plurality of requester devices:
(a) determining service-specific information using device data communicated by at least one of (i) the respective requester device and (ii) a respective provider device associated with a service provider entity that is matched to the given service request;
(b) detecting a trigger based on the service-specific information;
(C) in response to detecting the trigger, generating, based on the service-specific information, a synthetic message from (i) a first device selected from the respective requester device and the respective provider device to (ii) a second device selected from the respective requester device and the respective provider device.
